(19) United States
(12) Patent Application Publication
(10) Pub. No.: US 2012/0180943 A1
(43) Pub. Date: Jul. 19, 2012

(54) Preheated Gas Evacuated High Pressure Plastic Laminating System

(75) Inventor: Eric B. Strauss, Longmont, CO (US)

(73) Assignee: EBS Concepts, LLC

(21) Appl. No.: 13/353,185

(22) Filed: Jan. 18, 2012

Related U.S. Application Data
(60) Provisional application No. 61/461,586, filed on Jan. 19, 2011.

(51) Int. Cl. B32B 37/10

(52) U.S. Cl. 156/222; 156/382

(57) ABSTRACT

An inventive lamination method for producing laminates from a plurality of layers of laminatable material.

This United States Non-Provisional patent application claims the benefit of U.S. Provisional Patent Application No. 61/461,586, filed Jan. 19, 2011, hereby incorporated by reference herein.

### I. BACKGROUND

Conventionally, laminate is constructed by uniting two or more layers of material together. The process of creating a laminate conventionally refers to the placing an adherent material between layers of material and treating the stack of material to heat or pressure, or both. Certain substantial problems related to the conventional method of producing laminates and the laminates produced using conventional methods remain unresolved.

One substantial problem with conventional methods of producing a laminate can be that the layers of laminatable material are open to the environment which allows contaminants to associate with the laminate. Conversely, laminatable materials can contaminate the environment.

Another substantial problem with conventional methods of producing laminate can be that the adherent material generates gas bubbles which can become entrapped between the laminates.

Another substantial problem can be that conventional methods of producing laminate do, not control the temperature of the laminatable material between the heat source and the molds in which the laminatable materials are disposed for pressing.

Another substantial problem can be that the amount of pressure applied to the laminatable materials can be insufficient to generate laminates which resist penetration.

### II. SUMMARY OF THE INVENTION

Accordingly, a broad object of the invention can be to provide devices useful in producing laminates and methods of producing a laminate from a plurality of layers of laminatable material which provide a barrier between the plurality of layers of laminatable material and the surrounding environment.

Another broad object of the invention can be to provide a variable volume container in which a plurality of layers of laminatable material can be placed for lamination and which can be evacuated of atmospheric gases and gases generated by the plurality of layers of laminatable material and adherent material during the production of the laminate to separate the laminatable material from the environment, to control temperature of the laminatable materials and control or remove atmospheric gases and gases generated by the plurality of layers of laminatable material during the lamination process.

Naturally, further objects of the invention are disclosed throughout other areas of the specification, drawings, photographs, and claims.

### III. A BRIEF DESCRIPTION OF THE DRAWINGS

FIG. 1 is a perspective view of at least two laminatable layers of material along with the corresponding release layers and breather layers located in the open condition of a variable volume container in accordance with a particular embodiment of the inventive lamination method.

FIG. 2 is a perspective view of at least two laminatable layers of material along with the corresponding release layers and breather layers located in the closed condition of an evacuated variable volume container in accordance with a particular embodiment of the inventive lamination method.

FIG. 3 is a perspective view of the closed condition of the evacuated variable volume container located within a heated enclosure or heated and pressurized enclosure.

FIG. 4 is a perspective view of the evacuated variable volume container located in a particular configuration of press mold.

FIG. 5 is a perspective view of the closed condition of the evacuated variable volume container pressed between a first mold part and a second mold part of a press mold.

FIG. 6 is a perspective view of the evacuated variable volume container located in a particular configuration of press mold.

FIG. 7 is a perspective view of the closed condition of the evacuated variable volume container pressed between a first mold part and a second mold part of a press mold.

FIG. 8 is a perspective view of the closed condition of the evacuated variable volume container having reduced pressure within to consolidate a laminatable stack.

FIG. 9 is a perspective view of the open condition of the variable volume container for removal of a consolidated laminated stack.

FIG. 10 is a perspective view of a laminate produced by the inventive method in the form of a flat sheet.

FIG. 11 is a perspective view of the closed condition of the evacuated variable volume container having reduced pressure within to consolidate a laminatable stack.

FIG. 12 is a perspective view of the open condition of the variable volume container for removal of a consolidated laminated stack.

FIG. 13 is a perspective view of a laminate produced by the inventive method in the form of hollow hemisphere.

### IV. DETAILED DESCRIPTION OF THE PREFERRED EMBODIMENTS

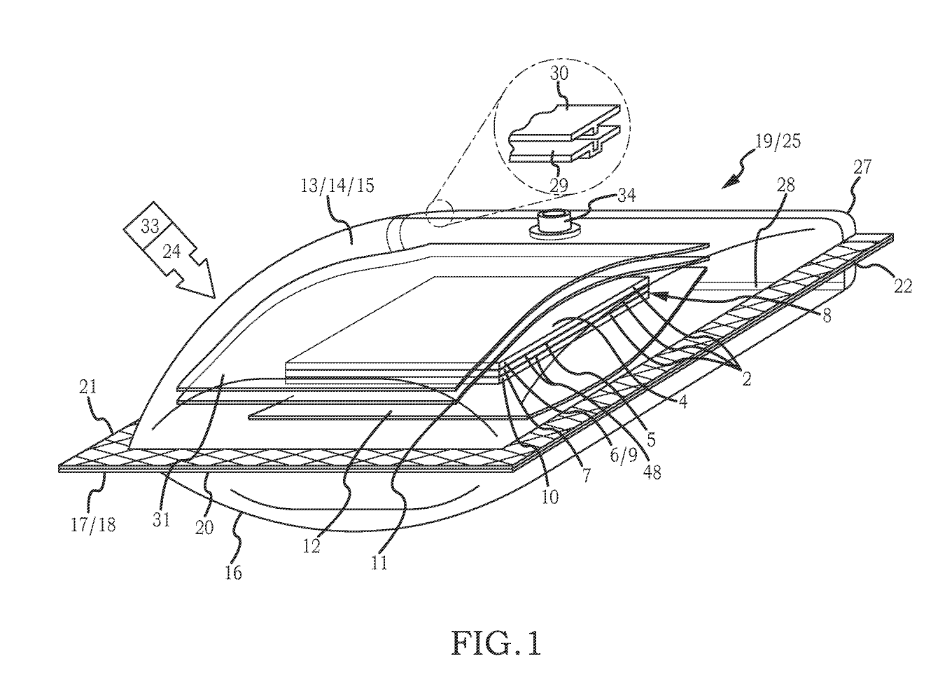

Generally referring to FIGS. 1-11 and the description below, an inventive lamination system including apparatus and methods for producing a laminate (1) is shown and described. For the purposes of this invention the term “laminate” means a material constructed by uniting two or more layers of laminatable material (2) together in accordance with one or more steps of the inventive lamination method as shown in the figures and described below. The laminate (1) produced by the inventive lamination method can take a wide and numerous variety of configurations from substantially planar sheets (as shown by the example of FIG. 10) to three dimensional forms (as shown by the example of FIG. 14) depending upon the application.

Now referring primarily to FIG. 1, the inventive lamination method can include the step of obtaining or stacking at least two layers of laminatable material (2) which can be united by the application of sufficient amounts of heat and pressure. While FIG. 1 provides a non-limiting example of three layers of laminatable material (2), the inventive method is not so limited and any number of layers of laminatable material (2) can be utilized with the inventive method depending upon the application. The layers of laminatable material (2) can be the same, similar, or different as to composition of material. The layer of laminatable material (2) can be in the form of sheets, which can be obtained as woven or non-woven materials, or the like. As examples, the layers of laminatable materials (2) can include sheets or material woven from: boron carbide, silicon carbide, alumina, alumina titanium, carbon; a para-aramid fiber such as KEVLAR, polypropylene such as INNEGRA available from Innegra Technologies, a ultra-high molecular weight polyethylene such as DYNEEMA or SPECTRA, s-glass, e-glass, or the like.

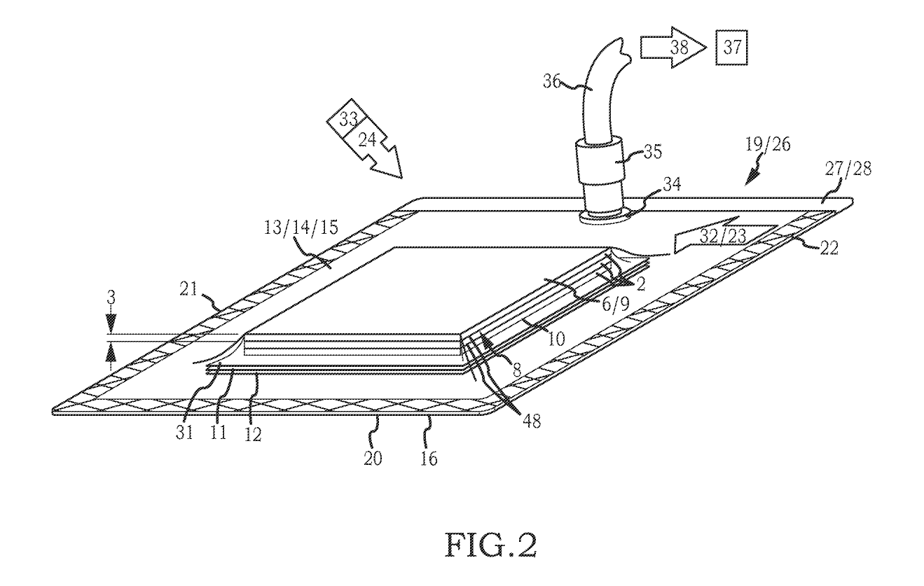

Each of the layers of laminatable material (2) can have a thickness (3) disposed between a first side (4) and a second side (5) (as shown by the example of FIG. 2). The at least two layers of laminatable material (2) can be stacked to engage the first side (4) of a first layer of laminatable material (6) against the second side (5) of a second layer of laminable material (7) and repeated until the number of layers of laminatable material (2) are sufficient for the particular application. The stacked layers of laminatable material (2) (also referred to as a laminatable stack (8)) have a top layer of laminatable material (9) and a bottom layer of laminatable material (10).

An amount of adherent material (48) (more particularly as to certain embodiments a resin) can be disposed between the layers of laminatable material (2). The amount of resin (48) can be provided as a separate material or the layers of laminatable material (2) can be pre-impregnated with the amount of resin (48). The resin (48) can be any one or a combination of resins. Examples of resins (48) useful in bonding the layers of the laminatable material (2), include: phenolic, epoxy, polyethylene terephthalate, vinylester, polyimides, bis(maleimide/diallybisphenol A, cyanate esters, thermoplastics, polypropylene, nylon, or the like.

As to certain embodiments, one or more layers of laminate (1) produced as herein described or otherwise obtained can be located in the variable volume container (13) and treated by the apparatus and methods described herein.

In another step, the inventive method can but does not necessarily further include engaging a first release layer (11) with the bottom layer of laminatable material (10) (or laminate (1)). The first release layer (11) provides an interface which prevents contact between the bottom layer of laminatable material (10) and other the surfaces of other materials during subsequent steps in the lamination method. Certain embodiments of the invention may not include a first release layer (11) engaged with the bottom layer of laminatable material (10) (or laminate) (as shown in the example of FIG. 1), or can include a first release layer (11) engaged with the bottom layer of laminatable material (10) (or laminate (10)) and a second release layer (12) engaged with the first release layer (11) (as shown in the example of FIG. 2); however, the invention is not so limited and any number of release layers can be utilized depending upon the embodiment or application.

In another step, embodiments of the inventive method can further include engaging a first release layer (11) with the bottom layer of laminatable material (10) (or laminate (1)) and the second release layer (12) with the top layer of laminatable material (9) (or laminate) (as shown in the example FIG. 1). The second release layer (12) can provide an interface which prevents contact between the between the top layer of laminatable material (9) (or laminate (1)) and other the surfaces of other materials during subsequent steps in the lamination method. Certain embodiments of the invention may not include a first release layer (11) or second release layer (12) correspondingly engaged with the bottom layer of laminatable material (9) (or laminate (1)) and top layer laminatable material (10) (or laminate (1)), or can include a first release layer (11) engaged with the bottom layer of laminatable material (10) (or laminate (1)) and a second release layer (12) engaged with the first release layer (11) (or laminate (1)) (as shown in the example of FIGS. 2 through 4); however, the invention is not so limited and any number of release layers can be utilized depending upon the embodiment or application. The composition of the second release layer (12) may be selected depending on the composition of the top layer of laminatable material (9) engaged by the second release layer (12). Because the top layer of laminatable material (9) can be different than the bottom layer of laminatable material (10) the first release layer (11) and the second release layer (12) can be, but are not necessarily, different in composition.

For the purposes of the inventive method the term “release layer” includes any type of material which can be engaged to the bottom layer of laminatable material (10) or the top layer of laminatable material (9) during the inventive lamination method for the production of the laminate (1) and can be subsequently removed from the laminate (1) without a substantial amount of the release layer (11) (12) remaining engaged with the laminate (1). The composition of the first release layer (11) may be selected depending on the composition of the bottom layer of laminatable material (10) engaged by the first release layer (11). As examples, the first release layer (11) (or second release layer, or a plurality of release layers) can include: a fluorocarbon such as TEFLON, polytetrafluoroethylene coated fiberglass or silicon treated nylon 66 such as PEEL-PLY available from Airtech International, Inc., steel, aluminum, silicon, latex, rubber, or the like.

In another step, the inventive method can further include providing a variable volume container (13) having at least one flexible side wall (14). The variable volume container (13) can for example take the constructional form of two superimposed sheets of flexible material (15)(16) having superimposed edges (17)(18) which can in part be permanently sealed to provide as the remaining part of the superimposed edges (17)(18) a sealable or releasably sealable opening element (19). As shown by FIG. 1, as one example, the two superimposed sheets of flexible material (15)(16) can be permanently sealed along three superimposed edges (17)(18) (the bottom edge (20) and two side edges (21)(22)) to provide the sealable opening element (19) which allows access to the inside of the variable volume container (13). As used herein, “permanently sealed” means that these edges are not intended to be opened during use of the variable volume container (13); and are not releasably sealable and are sufficiently sealed to allow retention of a vacuum pressure (23) within the variable volume container (13). The vacuum pressure (23) being lower pressure relative to atmospheric pressure (24), as further described below. Any method known to those of skill in the art, such as heat sealing, can be use to create the permanently sealed portion of the superimposed edges (17)(18) of the variable volume container (13). Variable volume containers (13) including more than two superimposed sheets of material (15)(16) are also within the scope of the present invention. The variable volume container (13) can have a configuration which is square or rectangular as shown in the example of FIGS. 1 and 2 and can operate between the open condition (25) shown in FIG. 1 and the closed condition (26) shown in FIG. 2. The variable volume container (13) can be produced from any material compatible with the pressure and temperature applied to the laminatable stack (8) to consolidate a laminate (1) or applied to the laminate (1).

As to particular non-limiting embodiments of the inventive method, the sealable opening element (19) can provide use of a pressure sensitive adhesive (27) coupled to the superimposed edge(s) (17)(18) which are not permanently sealed. The pressure sensitive adhesive (27) can be protected from inadvertent adherence. The phrase “protected from inadvertent adherence” means that the pressure sensitive adhesive (27) bearing superimposed edge (17) does not prematurely stick to a target surface (28) of the other superimposed edge (18) or to another portion of the superimposed sheets of flexible material (15)(16), or to any other surface, until activation of the pressure sensitive adhesive (27) by pressing the pressure sensitive adhesive (27) against the opposed target surface (29). Pressing the pressure sensitive adhesive (27) against the opposed target surface (29) results in a releasable seal generating the closed condition (26) of the variable volume container (13) as shown in FIG. 2.

As to other particular embodiments of the inventive method, the sealable opening element (19) can provide use of a groove element (29) matable with a groove engaging element (30). Pressing the groove engaging element (30) into the groove element (29) can releasably seal to generate the closed condition (26) of the variable volume container (13) as shown in FIG. 2. Any method known to those of skill in the art which allows the opening element (19) to be sealed either releasably such as pressure sensitive adhesive (27) or a groove engaging element (30) into a groove element (29) or permanently such as heat sealing, can be used to generate the closed condition (26) of the variable volume container (13). It is to be understood that the closed condition (13) of the variable volume container (13) can be generated by the use of any method of sealing which allows retention of a vacuum pressure (23) within the variable volume container (13) relative to atmospheric pressure (24), as further described below.

The inventive method can further include the step of inserting the laminatable stack (8) having a top layer of laminatable material (9) and a bottom layer of laminatable material (10) (or laminate (1)) correspondingly engaged to the first release layer (11) and the second release layer (12) inside of the variable volume container (13).

In another step, the inventive method can further include inserting between the at least one flexible wall (14) of the variable volume container (13) and the first release layer (11) or inserting between the at least one flexible wall (14) and the second release layer (12) or between the flexible wall (14) and both of the first release layer (11) and the second release layer (12) at least one breather layer (31). As to certain embodiments, the breather layer (31) can be used without a first release layer (11), or without the second release layer (12), or without either, depending on the type of breather layer (31) and the type layers of laminatable material (2) or adherent material (48). For the purposes of this invention the term “breather layer” means a layer of material sufficiently porous and of sufficient dimensional configuration to allow or assist in transfer of gases (32) within the variable volume container (13) in response to the vacuum pressure (23) applied to the variable volume container (13). The vacuum pressure (23), typically applied at the interface between the at least one flexible wall (14) and the breather layer (31) correspondingly engaged with the first release layer (11) or second release layer (12), each correspondingly engaged to the laminatable stack (8) (as shown in the example of FIG. 1). Various types of breather layers (31) are described for example in U.S. Pat. Nos. 3,666,600; 4,062,917; 4,216,047; 4,353,855; and 4,548,859, each hereby incorporated by reference herein.

Now referring to primarily to FIG. 2, the inventive method can further include the step of sealing the sealable opening element (19) to generate the closed condition (26) of the variable volume container (13).

Again referring to FIG. 2, while certain embodiments of the invention can be practiced without evacuating gases (32) from the variable volume container (13) (the inside of the container at atmospheric pressure) the inventive method can further include the step of evacuating gases (32) from inside the variable volume container (13). For the purposes of the inventive method, the term “gases” means the partial pressures of gases held within the closed condition (32) of the variable volume container (13) which can include a mixture of gases (32) including atmospheric gases (33) trapped within the variable volume container (13) by achieving the closed condition (26) of the variable volume container (13) along with gases produced or released by the laminatable stack (8) (or laminate (1)), the first release layer (11), the second release layer (12), the breather layer (31), adherent material (48), the variable volume container (13), or otherwise, at room temperature or at elevated temperatures as further described below, or due to achieving the vacuum pressure (23) inside of the variable volume container (13), as further described below. For the purposes of this inventive method the phrase “evacuating gases” means reducing pressure of the gas(es) (32) inside of the variable volume container (13) regardless of the means utilized. As shown in the non-limiting example of FIG. 2, the variable volume container (13) can further include an evacuation element (34) through which an amount of the gas(es) (32) contained inside of the variable volume container (13) can flow from inside the variable volume container (13) to a location outside of the variable volume container (13). The evacuation element (34) can have a configuration which mates with a terminal fitting (35) of a vacuum conduit (36) (as shown in the examples of FIGS. 2 through 4). A vacuum generator (37) can generate a vacuum (38) within the vacuum conduit (36) which can be fluidly coupled with the gases (32) inside of the variable volume container (13) by engaging the terminal fitting (35) of the vacuum conduit (36) to the evacuation element (34) of the variable volume container (13). A vacuum pressure (23) within the variable volume container (13) can remove the gases (32) within the variable volume container (13). Regardless of the form of the vacuum source, the resulting vacuum pressure (23) in the variable volume container (13) can be less than atmospheric pressure in the range of about 750 Torr and about 10 Torr. An advantage of achieving a vacuum pressure (23) in the variable volume container (13) can be that gases (32) contained in compositions making up the at least two laminatable layers (2) (or the one or more layers of laminate (1)) can be released prior to subsequent steps in the inventive lamination method, especially upon heating the laminatable stack (8) (or one or more layers of laminate (1)), as further described below.

Again primarily referring to FIG. 2, in another step, the inventive method can further include reducing the volume of the variable volume bag (13) in response to the vacuum pressure (23) inside of the variable volume container (13). In the particular embodiment of the inventive lamination method shown in FIG. 2, the two superimposed sheets of flexible material (15)(16) (or at least one flexible wall (14)) of the variable volume container (13) can be drawn against the laminatable stack (8) and associated first release layer (11) and second release layer (12) depending upon the embodiment, which can in part compressingly engage the at least two laminatable layers (2) together.

As to certain embodiments, the inventive method can further include the step of sealing the evacuation element (34) to retain the vacuum pressure (23) inside of the variable volume container (13), and uncoupling the terminal fitting (35) of the vacuum conduit (36) from the evacuation element (34) of the variable volume container (13). Typically, however, the vacuum (38) will be continuously applied to maintain the vacuum pressure (23) inside of the variable volume container (13) to remove gases (32) (including mixtures of gases generated by the laminatable stack (8) (one or more layers of laminate (1)) and other materials) during subsequent steps in the inventive method.

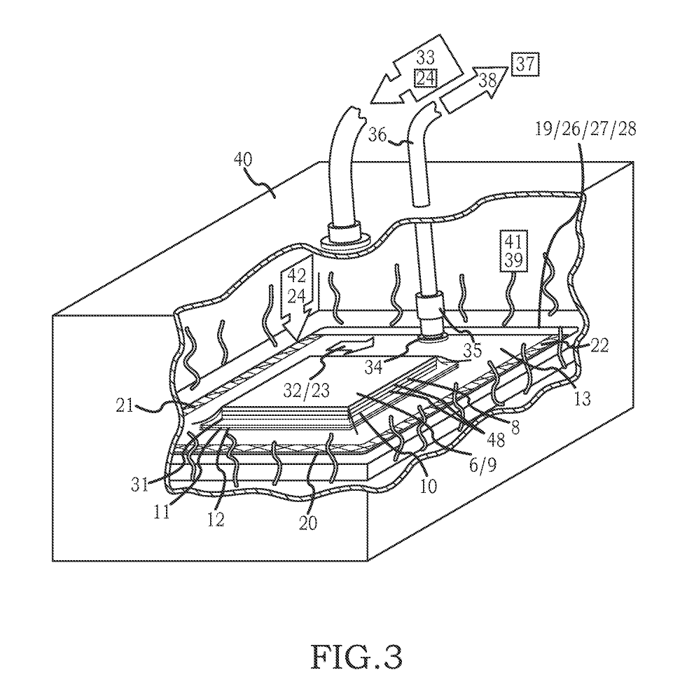

Now referring primarily to FIG. 3, the inventive method can further include the step of heating the laminatable stack (8) whether outside of or within the variable volume container (13). As to certain embodiments, the evacuated variable volume container (13) having within the laminatable stack (8) (or one or more layers of laminate (1)) along with the associated first release layer (11), second release layer (12) and breather layer (31) can be heated. As to certain embodiments of the inventive method, the heating step can be achieved during continuous evacuation of the variable volume container (13) to continuously maintain the vacuum pressure (23) inside of the variable volume container (13), at the vacuum pressure (23) above described regardless of the mode of operation of the vacuum generator (37). The evacuated variable volume container (13) containing the laminatable stack (8) (or one or more layers of laminate (1)) can be sufficiently heated to allow consolidation of the laminatable stack (8) for production of the laminate (1) or sufficiently heated to allow press molding of a laminate (1).

For the purposes of this invention the term “consolidation” means sufficient adherence between the at least two layers of laminatable material (2) to allow production of a laminate (1). Typically, the at least two layers of laminatable material (2) once consolidated will be substantially inseparable. The temperature (39) of the variable volume container (13) can be varied depending on a wide variety of lamination factors such as but not limited to: the composition, number, thickness, size, porosity, or other factors as to the at least two layers of laminatable material (2); or the vacuum pressure (23), atmospheric pressure (24), mold pressure, mold temperature, or other factors affecting the lamination process. The temperature (39) of the at least two layers of laminatable material (2) or the laminatable stack (8) can be in the range of about 10 degrees Celsius (“C.°”) and about 400 C.° depending on the above described factors.

Regardless of the heat source a wide variety of laminates (1) can be produced where the temperature is selected from the group including or consisting of: between about 10° C. and about 50° C., between about 25° C. and about 75° C., between about 50° C. and about 100° C., between about 75° C. and about 125° C., between about 100° C. and about 150° C., between about 125° C. and about 170° C., between about 150° C. and about 200° C., between about 175° C. and about 225° C., between about 200° C. and about 250° C., between about 225° C. and about 275° C., between about 250° C. and about 300° C., between about 275° C. and about 325° C., between about 300° C. and about 350° C., between about 325° C. and about 375° C., and between about 350° C. and about 400° C.

Again referring to FIG. 3, as to certain embodiments for the inventive lamination method, heating of the evacuated variable volume container (13) and the laminatable stack (8) contained inside of the variable volume container (13) can be achieved by locating the evacuated variable volume container (13) inside of a heated enclosure (40), such as an oven, capable of maintaining a constant temperature (39) or generating a temperature gradient (41) (pre-selected change(s) in temperature (39) over a period of time which can be implemented automatically (by mechanical or computer implemented means) or manually to heat the evacuated variable volume container (13) including the laminatable stack (8) (or laminate) through a temperature gradient (41) or to a particular temperature (39).

Again referring primarily to FIG. 3, the inventive method can further include the step of increasing pressure of the atmosphere gases (33) about the external surface of the evacuated variable volume container (13) having within the laminatable stack (8) along with the associated first release layer (11), second release layer (12) and breather layer (31). As to certain embodiments of the inventive lamination method, the step of increasing pressure of the atmosphere gases (33) about the external surface of the evacuated variable volume container (13) can be achieved during continuous evacuation of the variable volume container (13) to continuously maintain the vacuum pressure (23) inside of the variable volume container (13), regardless of the mode of operation of the vacuum generator (37).

The evacuated variable volume container (13) containing the laminatable stack (8) (or one or more layers of laminate (1)) can be sufficiently externally pressurized to urge the at least two layers of laminatable material (2) (or at least one flexible side wall (14)) in the laminatable stack (8) (one or more layers of laminate) against one another to facilitate consolidation for production of the laminate (1) or prepare the laminate (1) for press molding. The pressure of the atmospheric gases (33) in contact with the external surface of the variable volume container (13) can be varied depending on a wide variety of lamination factors such as but not limited to: the composition, number, thickness, size, porosity, or other factors as to the at least two layers of laminatable material (2); or the vacuum pressure (23), atmospheric pressure (24), mold pressure, mold temperature, or other factors affecting the lamination process. The pressure of the atmosphere gases (33) in contact with the external surface of the variable volume container (13) can be in the range of about 15 pounds per square inch (“psi”) and about 50,000 psi depending on the above described factors.

Again referring to FIG. 3, as to certain embodiments for the inventive lamination method, the step of increasing pressure of the atmosphere gases (33) about the external surface of the evacuated variable volume container (13) and the step of heating of the evacuated variable volume container (13) and the laminatable stack (8) (or laminate (1)) contained inside can be achieved by locating the evacuated variable volume container (13) inside of an pressurized heated enclosure (42), such as an autoclave, capable of maintaining a constant external pressure (24) at a constant temperature (39) or generating a pressure gradient (42) or a temperature gradient (41) (pre-selected change(s) in the pressure or temperature, or both, over a period of time) which can be implemented automatically (by mechanical or computer implemented means) or manually to pressurize and heat the evacuated variable volume container (13) including the laminatable stack (8) through the pressure gradient (42) and temperature gradient (41) or to a particular atmospheric pressure (24) at a particular temperature (39).

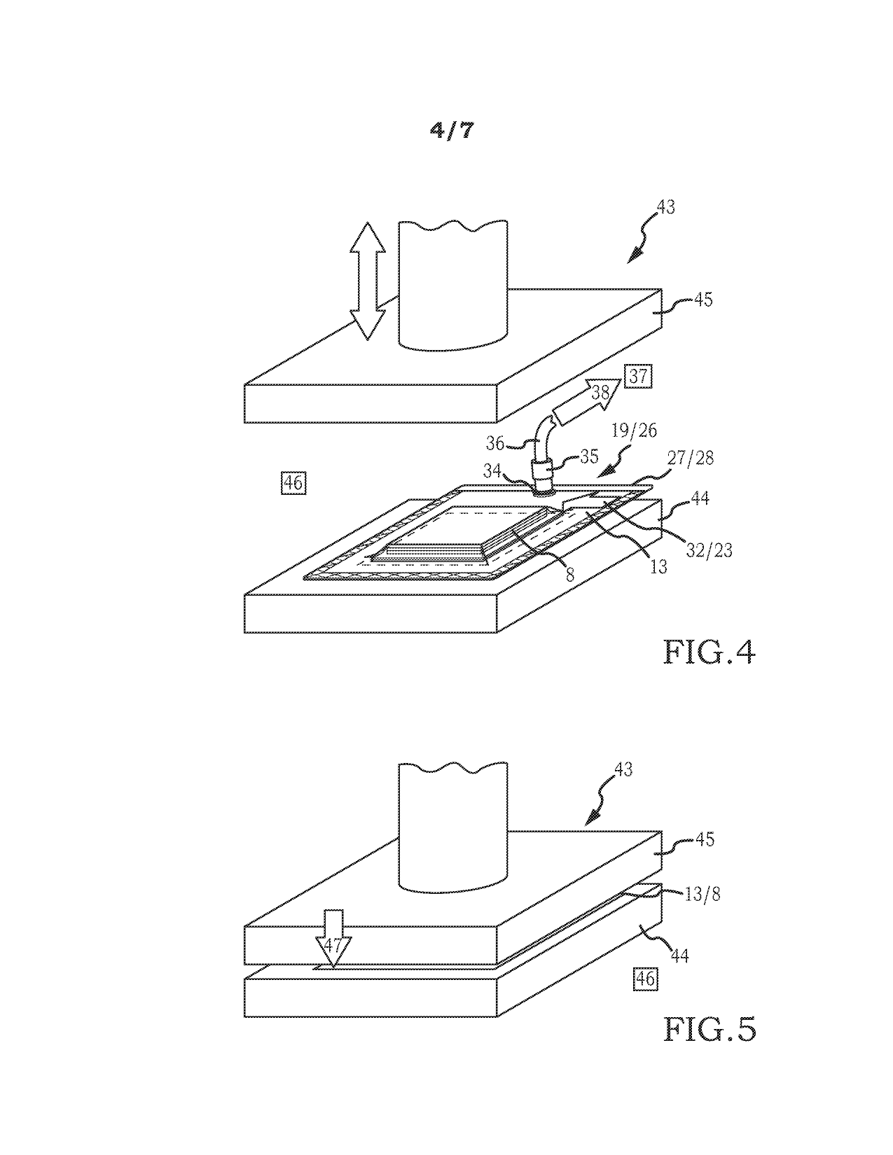

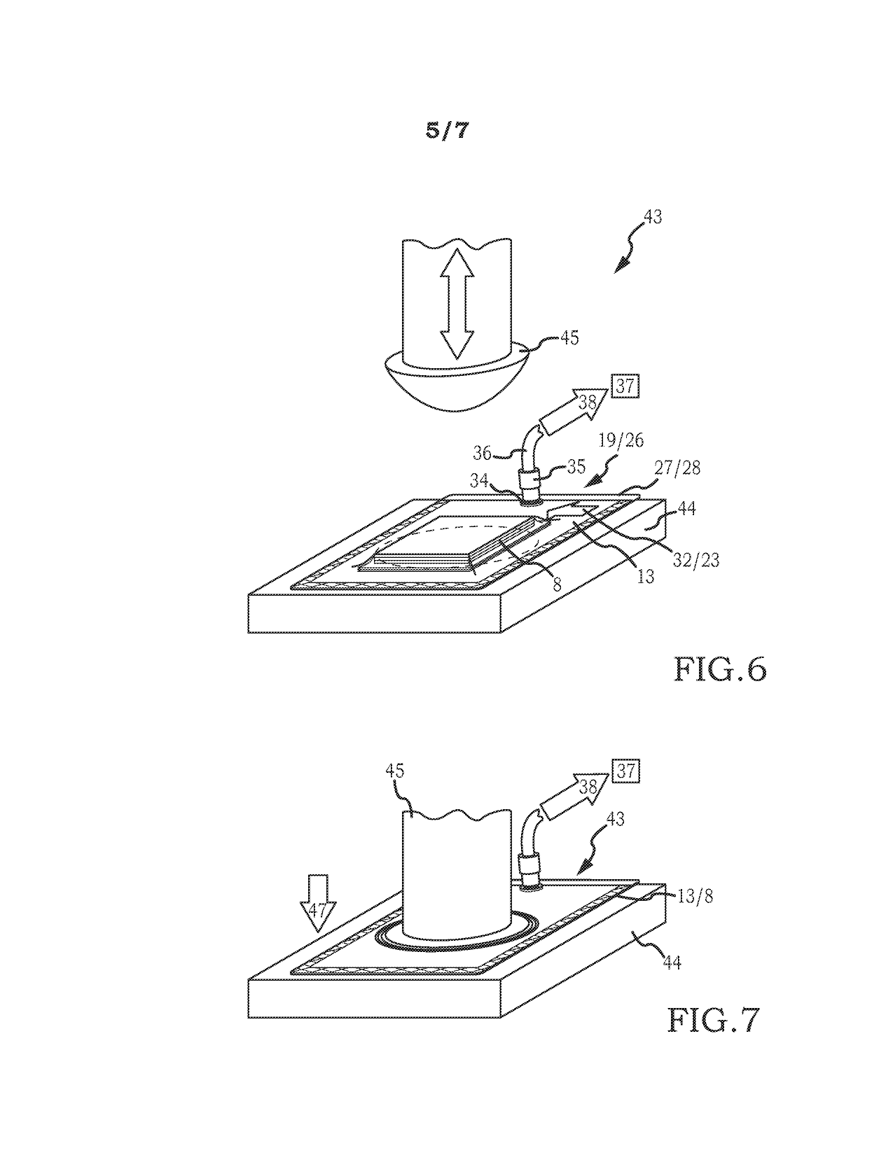

Now referring to FIGS. 4 and 6, the inventive lamination method can further include the step of placing the laminatable stack (8) (or laminate (1)) in a press mold (43). The press mold (43) can have a first mold part (44) configured to be mated with a second mold part (45). The first mold part (44) and the second mold part (45) can take a numerous and wide variety of configurations. As one example, the matable portions of the first mold part (44) and the second mold part (45) can be substantially flat or planar as shown in the example of FIG. 5. As a second example, the first mold part (44) can be recessed or provide a receding or hollow part while the second mold part (45) can be correspondingly mateably raised as shown in the example of FIG. 7. While FIG. 6 shows a first mold part (44) which provides a recessed hemisphere and the second mold part (45) which provides a corresponding mateable raised hemisphere, the inventive method is not so limited, and any manner of corresponding matable recessed and raised mold parts (44) (45) useful in producing a correspondingly configured laminate (1) can be utilized. Additionally, an advantage of the inventive lamination method can be that the first mold part (44) and the second mold part (45) can be utilized at ambient temperature (46) and do not require heating prior to placing in the press mold (43) the variable volume container (13) having within the heated evacuated laminatable stack (8) (or one or more layers of laminate (1)) along with the associated release layers (11) (12) and breather layer (31) for subsequent production of the laminate (1); however, this advantage is not intended to preclude embodiments of the inventive method that use preheated press molds (43). To place the laminatable stack (8) (or laminate (1)) in the press mold (43), the first mold part (44) and the second mold part (45) can be disposed a sufficient distance apart to allow the laminatable stack (8) to be placed between the first mold part (44) and the second mold part (45). As to certain embodiments of the method, the heated evacuated variable volume container (13) having within the laminatable stack (8) (or laminate (1)) along with the associated first release layer (11), second release layer (12) and breather layer (31) can be placed in the press mold (43). As to other embodiments of the inventive method, the step of placing the laminatable stack (8) in the press mold (43) can be achieved during continuous evacuation of the variable volume container (13) to continuously maintain the vacuum pressure (23) inside of the variable volume container (13), at the vacuum pressure (23) above described regardless of the mode of operation of the vacuum generator (37).

Now referring primarily to FIGS. 5 and 7, the inventive lamination method can further include the step of press molding the heated laminatable stack (8) (or one or more layers of laminate (1)) contained within the evacuated variable volume container (13) between the first mold part (44) and the second mold part (45). Press molding includes moving the first mold part (44) and the second mold part (45) to exert sufficient mold pressure (47) on external surface of the evacuated variable volume container (13) having within the heated laminatable stack (8) to consolidate the at least two layers (2) to produce the laminate (1). The laminate (1) resulting from the press molding can remain contained within the evacuated variable volume container (13). The amount of mold pressure (47) transferred to the heated laminatable stack (8) (or heated one or more layers of laminate (1)) within the evacuated variable volume container (13) can be sufficient to consolidate the at least two layers of laminatable material (2) over a period of time. When utilizing pre-consolidated laminate (1) prepared by the inventive method described herein or other by another method, there can be an advantage in applying heat and pressure to the laminate (1) in the variable volume container (13) evacuated to remove gases in that the laminate can further consolidate, maintain consolidation, or reduce loss of consolidation which can maintain or increase advantageous properties of the laminate, such a strength, puncture resistance, resistance to delamination, or the like While the amount of mold pressure (47) utilized depends upon the lamination factors or the mold factors above described, the amount of mold pressure (47) exerted on the heated laminatable stack (8) within the evacuated variable volume container (13) to consolidate the at least two layers of laminatable material (2) (or mold the laminate (1)) can be greater than 1,500 psi, or can be greater than 3,000 psi, or can be in the range of about 3,000 psi to about 10,000 psi. In particular, as to those embodiments of the invention which use a press mold (43) at ambient temperature, the mold pressure (47) transferred to the laminatable stack (8) (or the laminate (1)) can be sufficient to consolidate the heated laminatable stack (8) (or mold the laminate (1) without loss of the above described advantageous properties) within the evacuated variable volume container (13), which can occur in a wide range of between about 15 psi and about 50,000 psi. In regard to certain methods, increased resistance of the laminate (1) to penetration can be achieved with increased pressure of between about 75 psi and about 250 psi. Certain embodiment of the invention can be performed at between 1,500 psi and about 50,000 psi. The period of time in which the amount of pressure is applied to the laminatable stack (8) can be as little as about one second and there is no limit as to time and the pressure can be applied the amount of time necessary to consolidate the laminatable stack (8) depending upon the lamination factors and mold factors above described.

Whether the pressure source of the amount pressure applied to the laminatable stack (8) (or laminate (1)) comprises at least one flexible side wall (14) of the variable volume container (13) responsive to a vacuum pressure (23), or responsive to pressure of the atmospheric gases (33) in contact with the external surface of the variable volume container (13), or responsive to a press or press mold (43), the pressure can be selected from one or more of the pressures included in or selected from the group consisting of: between about 15 pounds per square inch and about 75 pounds per square inch, between about 50 pounds per square inch and about 150 pounds per square inch, between about 75 pounds per square inch and about 250 pounds per square inch, between about 200 pounds per square inch and about 1000 pounds per square inch, between about 500 pounds per square inch and about 1,500 pounds per square inch, between about 1,000 pounds per square inch and about 3,000 pounds per square inch, between about 2,000 pounds per square inch and about 4,000 pounds per square inch, between about 3,000 pounds per square inch and about 5,000 pounds per square inch, between about 4,000 pounds per square inch and about 6,000 pounds per square inch, between about 5,000 pounds per square inch and about 7,000 pounds per square inch, between about 6,000 pounds per square inch and about 8,000 pounds per square inch, between about 7,000 pounds per square inch and about 9000 pounds per square inch, between about 8,000 pounds per square inch and about 10,000 pounds per square inch, between about 9,000 pounds per square inch and about 20,000 pounds per square inch, between about 15,000 pounds per square inch and about 25.000 pounds per square inch, between about 20,000 pounds per square inch and about 30,000 pounds per square inch, between about 25,000 pounds per square inch and about 35,000 pounds per square inch, between about 30,000 pounds per square inch and about 40,000 pounds per square inch, between about 35,000 pounds per square inch and about 45,000 pounds per square inch, and between and about 40,000 pounds per square inch and about 50,000 pounds per square inch.

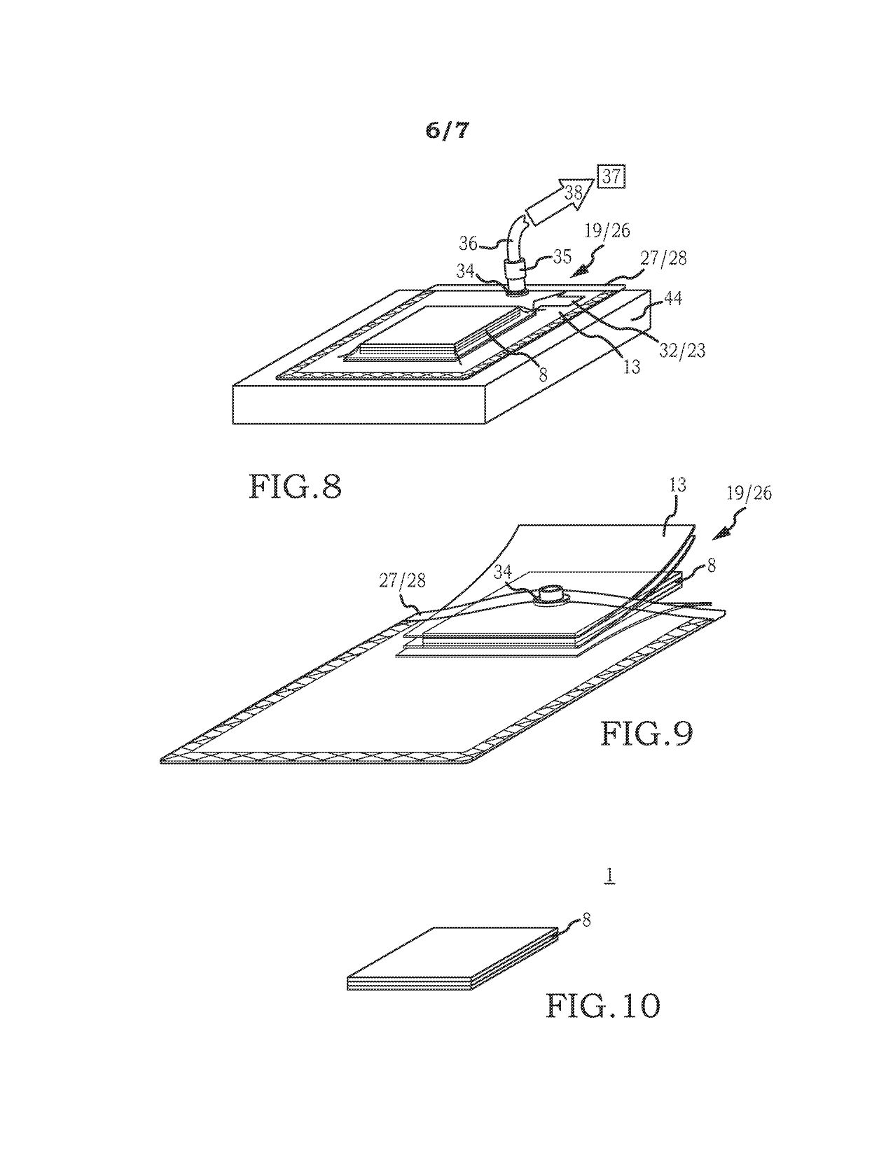

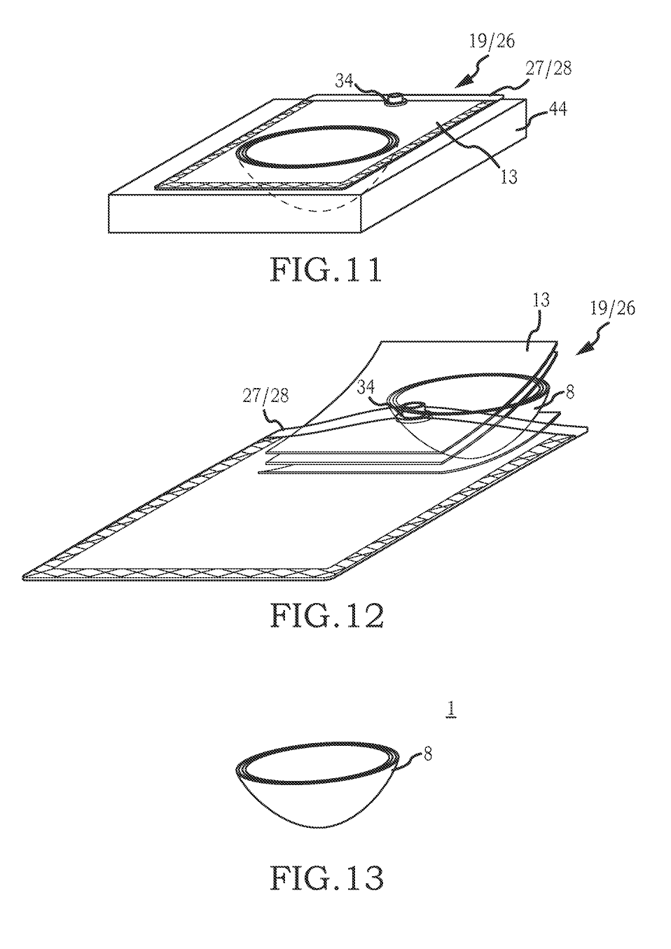

Now referring primarily to FIGS. 8 and 11, the inventive lamination method can further include the step of removing a laminate (1) contained within the evacuated variable volume container (13) from the press mold (43). Removal of the laminate (1) contained within the evacuated variable volume container (13) can be achieved by separating the first mold part (44) from the second mold part (45) to allow release of the laminate (1) contained within the evacuated variable volume container (13) from the first mold part (44) or the second mold part (45) of the press mold (43). Certain embodiments of the inventive method can further include the step of cooling the laminate (1) contained within the evacuated variable volume container (13) for a period of time prior to removal from the press mold (43) such period of time sufficient to retain the configuration of the laminate (1) outside of the press mold (43). The inventive lamination method can further include the step of disengaging the breather layer (31) from the first release layer (11) and disengaging the first release layer (11) and the second release layer (12) from the opposed sides of the laminate (1).

Now referring to FIGS. 9 and 12, the inventive lamination method can further include the step of removing the laminate (1) from the variable volume container (13). Removal of the laminate (1) can include the step of releasing the vacuum pressure (23) within the variable volume container (13). Release of the vacuum pressure (23) within the variable volume container (13) can be achieved as to certain embodiments of the inventive method disengaging the terminal fitting (35) of the vacuum conduit (36) from the evacuation element (34) to allow ingress of atmospheric gases (33) into the variable volume container (13). As to other embodiments of the inventive method the release of vacuum pressure (23) can be achieved by generating the open condition (25) of the variable volume container (13) by opening the sealable opening element (19). The laminate (1) along with the associated first release layer (11) and second release layer (12) and breather layer (31) can be removed from the variable volume container (13).

Now referring primarily to FIGS. 10 and 13, the invention can further include the step of producing a laminate (1) by use of the inventive lamination method. The laminate (1) includes the consolidation of the at least two layers of laminatable material (2) by stepwise application of any of the embodiments of the inventive lamination method above described.

As can be easily understood from the foregoing, the basic concepts of the present invention may be embodied in a variety of ways. The invention involves numerous and varied embodiments of a laminate and methods of producing a laminate.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of “laminate” should be understood to encompass disclosure of the act of “laminating”—whether explicitly discussed or not—and, conversely, were there effectively disclosure of the act of “laminating”, such a disclosure should be understood to encompass disclosure of “a laminate” and even a “means for laminating.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

Moreover, for the purposes of the present invention, the term “a” or “an” entity refers to one or more of that entity; for example, “a layer of laminatable material” refers to one or more layers of laminatable material. As such, the terms “a” or “an”, “one or more” and “at least one” can be used interchangeably herein. Furthermore, an element “selected from the group consisting of” refers to one or more of the elements in the list that follows, including combinations of two or more of the elements.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Thus, the applicant(s) should be understood to claim at least: i) each of the laminates herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1-61. (canceled)

62. A method of producing a laminate product, comprising:
a) locating a laminate inside a variable volume container;
b) evacuating an amount of gas from inside of said variable volume container;
c) applying heat to said laminate located inside of said variable volume container evacuated of said gas;
d) positioning said laminate located inside of said variable volume container evacuated of said gas in a press mold; and
e) applying pressure to said laminate located inside of said variable volume container by operation of a press mold, said heat and said pressure sufficient to achieve a configuration in said laminate which corresponds to said press mold.

63. The method of producing a laminate product of claim 62, wherein evacuating said gas from inside of said variable volume container comprises generating a vacuum pressure inside of said variable volume container.

64. The method of producing a laminate product of claim 63, wherein said vacuum pressure generated inside of said variable volume container is between about 750 Torr and about 10 Torr.

65. The method of producing a laminate product of claim 62, wherein said gas in part includes a mixture of gases released by said laminate during production of said laminate.

66. The method of producing a laminate product of claim 62, wherein said pressure is between about 15 pounds per square inch and about 50,000 pounds per square inch.

67. The method of producing a laminate product of claim 62, wherein applying said heat achieves a temperature of between about 10° C. and about 400° C.

68. The method of producing a laminate product of claim 62, where in applying said heat and said pressure occurs over a period of time.

69. The method of producing a laminate product of claim 68, further comprising pre-selecting changes in said pressure over said period of time.

70. The method of producing a laminate product of claim 68, further comprising pre-selecting changes in said temperature over said period of time.

71. The method of producing a laminate product of claim 62, further comprising locating a first release layer between a flexible wall of said variable volume container and a top layer of said laminate.

72. The method of producing a laminate product of claim 71, further comprising locating a second release layer between said flexible wall of said variable volume container and a bottom layer of said laminate.

73. The method of producing a laminate product of claim 72, further comprising locating a breather layer between said flexible wall of said variable volume container and said first release layer or said second release layer.

74. The method of producing a laminate product of claim 62, further comprising sealing said variable volume container after locating said laminatable stack inside said variable volume container.

75. A system for production of a laminate product, comprising:
a) a variable volume container having a configuration to receive a laminate;
b) a vacuum source coupled to said variable volume container to evacuate an amount of gas from inside of said variable volume container;
c) a heat source configured to heat said laminate within said variable volume container within said variable volume container coupled to said vacuum source; and
d) a press mold adapted to apply a pressure to said laminate located inside of said variable volume container, said heat and said pressure sufficient to achieve a configuration in said laminate which corresponds to said press mold.

76. The system for production of a laminate product of claim 75, wherein said vacuum source generates a vacuum pressure to evacuate gas from inside of said variable volume container.

77. The system for production of a laminate product of claim 76, wherein said vacuum pressure generated inside of said variable volume container is between about 750 Torr and about 10 Torr.

78. The system for production of a laminate product of claim 75 wherein said gas in part includes a mixture of gases released by said laminate.

79. The system for production of a laminate product of claim 75, wherein said pressure is between about 15 pounds per square inch and about 50,000 pounds per square inch.

80. The system for production of a laminate product of claim 75, wherein said heat source achieves a temperature of between about 10° C. and about 400° C.

81. The system for production of a laminate product of claim 75, further comprising a period of time over which said heat and said pressure act on said laminate in said press mold.

82. The system for production of a laminate product of claim 81, further comprising one or more pre-selected changes in said pressure over said period of time.

83. The system for production of a laminate product of claim 81, further comprising one or more pre-selected changes in said temperature over said period of time.

84. The system for production of a laminate product of claim 75, further comprising a first release layer located between a flexible wall of said variable volume container and a top layer of said laminate.

85. The system for production of a laminate product of claim 84, further comprising a second release layer located between said flexible wall of said variable volume container and a bottom layer of said laminate.

86. The system for production of a laminate product of claim 85, further comprising a breather layer located between said flexible wall of said variable volume container and said first release layer or said second release layer.

87. The system for production of a laminate product of claim 75, further comprising a sealable opening element coupled to said variable volume container.
